(19) United States
(12) Patent Application Publication
(10) Pub. No.: US 2004/0086068 A1
(43) Pub. Date: May 6, 2004

(54) Apparatus and method for processing a plurality of signals

(75) Inventor: Ming-Hsiung Lin, Taipei (TW)

Correspondence Address: BRUCE H. TROXELL, SUITE 1404, 5205 LEESBURG PIKE, FALLS CHURCH, VA, 22041, US

(73) Assignee: Extra Communication Tech. Co., Ltd.

(21) Appl. No.: 10/342,246

(22) Filed: Jan. 15, 2003

(30) Foreign Application Priority Data
Oct. 25, 2002 (TW) 91124915

(51) Int. Cl. H04L 7/00

(52) U.S. Cl. 375/355

(57) ABSTRACT

A method for processing a plurality of signals, comprising the steps of: sampling n samples from each of a plurality of analog signals Sᵢ(t), multiplying by corresponded m×n linearly independent function groups ᵢaⱼ(t), adding the resultants to establish the transformed signals S⁰ᵢ(t), summing all the transformed signals S⁰ᵢ(t) to produce a preliminary mixed signal SM(t); this preliminary mixed signal SM(t) being mathematically processed with the synchronous signal sin(qw₀t) and the interruption cancellation signal sin(pw₀t) which contains the basic angular frequency w₀ to establish a new signal SMS(t) for transmitting; wherein, SMS(t)=Sin(pw₀t)×SM(t)+Sin(qw₀t). In order to cancel interruptions during transmitting, the value of signal SMS(t) is zero at the boundaries of each time period. . In additions, the frequency range of the linearly independent signal ᵢaⱼ(t) is between

$${A}_{i} \frac{{T}_{1}}{v} Hz ∼ ( {A}_{i} \frac{{T}_{1}}{v} + \frac{{T}_{1}}{2 v} ) Hz and {A}_{i} \frac{{T}_{1}}{v} Hz ∼ ( {A}_{i} \frac{{T}_{1}}{v} + \frac{{T}_{1}}{2 v} ) Hz .$$

Moreover, to simplify the processing, appropriate intervals can be placed between every ᵢaⱼ(t).

### FIELD OF THE INVENTION

This invention relates to an apparatus and a method for processing a plurality of signals, more particularly, to an apparatus and method for processing a plurality of signals which can simultaneously transmit a plurality of signals in a single transmission line or channel and the bandwidth is invariant to the types or amount of the signals.

### BACKGROUND OF THE INVENTION

In the present age, the need of the data transmitting efficiency grows in an exponential rate. The lack of bandwidth is noticed in both digital and analogue data transmissions through both wired and wireless mediums, such as in internets, broadcasting channels, and cell phones,

Traditionally, two methods were used to increase the data transmitting capacity within a limited bandwidth. The first method is dividing a relatively wide bandwidth into several narrower bands so as to simultaneously transmit signals which have been pre-modulated into different bandwidths. Examples of this first method are the signal transmitting of traditional televisions and radios. Because high techniques are required and interferences easily occur during transmitting, only limited number of channels are available via this first transmitting method. Thus, the need of the bandwidth at the present age cannot be fulfilled.

The second method is cutting the plurality of signals into small segments and transmitting at different time under the same frequency. Segments of signal are reconnected at the receiving end. Data transmitting of the traditional internet is an example. However, this second data-transmitting method has low efficiencies and frequently resulting in internet jam while simultaneously transmitting large amount of signals.

The U.S. Pat. No. 6,442,224 B1 (which pattern right has been transferred to the inventor and is referred as Pat.224 hereafter) revealed a method and apparatus for mixing and separating a plurality of signals. As in the Pat. 224, linearly independent signals are separated, n samples (Sᵢ(tⱼ), j=1,2, . . . n) are taken from each of the separated m signals (Sᵢ(t), i=1,2, . . . m). The n samples were multiplied by linearly independent signals (such as m X n sets of different sinusoidal signals ᵢaⱼ(t)) and the products were summed to form a single mixed signal SM(t) for transmitting, wherein

$$S M ( t ) = {\sum }_{i = 1}^{m} {S}_{i}^{o} ( t ) , and {S}_{i}^{o} ( t ) = {\sum }_{j = 1}^{n} [ S i ( t j ) i a j ( t ) ] , i = 1 , 2 , … m ) .$$

Transmitting this single mixed signal SM(t) requires only single bandwidth which is the maximum bandwidth of the selected ᵢaⱼ(t). This single bandwidth is affected neither by the amount nor by the bandwidths of Sᵢ(t). Therefore, a plurality of signals can simultaneously be transmitted which resolving the problems about limited bandwidth in the prior techniques.

However, there are still some problems in Pat. 224.

(1) In pat. 224, the signal SM(t) is transmitted and received in segments with the time period [T₀, T₁] of each segment. A synchronous signal is transmitted first and followed by the main data signal SM(t) within each time period. At the receiving end, the main data signals are received after receiving the synchronous signal. Therefore, the time period [T₀, T₁] as described in Pat. 224 has to be separated into two intervals [T₀, T₁′] and [T₁′, T₁] wherein T₀<T₁′<T₁. The interval [T₀, T₁′] is referred as synchronizing time period which is used for transmitting the synchronous signal; whereas, the interval [T₁′, T₁] is referred as data period which is used for transmitting the main data signal SM(t). Consequently, the synchronizing time period causes a time delay and the main data signal SM(t) is not able to complete the whole cycle within the time period [T₀, T₁]. Thus, interruptions of the main data signal SM(t) may occur as described in FIG. 13.

(2) In Pat. 224, the method of selecting m x n sets of linearly independent signals ( such as sinusoidal signal ᵢaⱼ(t) ) is to equally cut the pre-determined bandwidth into several frequency bands to obtain signal ᵢaⱼ(t). This method is appropriate while in low frequency conditions. However, if in the high frequency conditions, the two consecutive frequency bands will be difficult to be separated and processed. For example, if the pre-determined maximum bandwidth is 4K Hz and will be cut into 100 bands, there will be a 40 Hz difference between two consecutive frequency bands. In low frequency condition such as 40 Hz versus 80 Hz, the signal is easy to be processed because 80 Hz is twice of 40 Hz. However, in high frequency condition such as 3600 Hz versus 3640 Hz, the frequency bands are almost overlapped and are difficult to be separated.

(3) In Pat. 224. solving simultaneous equations is a required procedure to separate mixed signals. However, the circuit for solving simultaneous equations is too huge and complicate to be designed. The efficiency of this circuit is sub-optimal due to prolonged calculation time. In additions, the total cost will rise.

Therefore, there is room for advancing the techniques revealed in Pat. 224.

### SUMMARY OF THE INVENTION

The first purpose of this invention is to provide a method and apparatus which can transmit mixed signals without interruptions within all time periods and the value of the mixed signals are zero at the boundaries of each time period.

The second purpose of this invention is to provide a method and apparatus for processing a plurality of signals which can mix a synchronous signal into the main data signal, transmit this mixed signal, and separate the synchronous signal at the receiving end. The separated synchronous signal is served as the time controller for the subsequent processing. Therefore, this method can transmit signals within the whole time period [T₀, T₁], complete the cycles (period) of the signals within each of the time period and avoid the interruptions caused by the intervals for transmitting synchronous signals as described in Pat. 224.

The third purpose of this invention is to provide a method and apparatus for processing of a plurality of signals, wherein, within the frequency range

$$( {A}_{i} \frac{{T}_{1}}{v} Hz ∼ ( {A}_{i} \frac{{T}_{1}}{v} + \frac{{T}_{1}}{2 v} ) Hz )$$

of the linearly independent signal ᵢaⱼ(t), appropriate intervals are placed between two consecutive frequency bands and the interval increased as the frequency increased so as to simplify the subsequent processing.

The forth purpose of this invention is to provide a method and apparatus for processing a plurality of signals, through this method and the circuit designed for implementing this method, solving homogeneous ordinary difference equations and obtaining some constant values so that the simultaneously transmitted synchronous signal and each of the linearly independent signals can be separated and reconstructed at the receiving end.

The fifth purpose of this invention is to provide a method and apparatus for processing a plurality of signals, through this method and the circuit designed for implementing this method, solving the homogeneous ordinary differential equations and obtaining some constant values so that the simultaneously transmitted synchronous signal and each of the linearly independent signals can be separated and reconstructed at the receiving end.

### BRIEF DESCRIPTION OF THE DRAWINGS

FIG. 1 is an embodiment of circuit blocks according to formula 4 of this invention.

FIG. 2 is an embodiment of circuit blocks according to formula 5 of this invention.

FIG. 3 is an embodiment of circuit blocks according to formula (6)-3 of this invention.

FIG. 4 is an embodiment of circuit blocks according to formula (8) of this invention.

FIG. 5 is an embodiment of circuit blocks according to formula (9)-1 of this invention.

FIG. 6, FIG. 7 and FIG. 8 are the diagrams of the circuit blocks for separating the mixed signals at the receiving end.

FIG. 9 and FIG. 10 represent an embodiment of circuit blocks according to formula (12) of this invention.

FIG. 11 and FIG. 12 demonstrate an embodiment of circuit blocks for processing a plurality of signal at the receiving end.

FIG. 13 is the potential output signal in the Pat. 224.

### DETAILED DESCRIPTION OF THE INVENTION

The method of this invention comprising the steps of sampling in samples from each of a plurality of analog signals Sᵢ(t), multiplying by corresponded m X n sets of linearly independent function groups ᵢaⱼ(t), summing the resultants to establish transformed signals S⁰ᵢ(t) and summing all the transformed signals S⁰ᵢ(t) to produce a preliminary mixed signal SM(t). This preliminary mixed signal SM(t) is not transmitted right away but is mixed with a synchronous signal sin(qw₀t) and an interruption cancellation signal sin(pw₀t) which contains a basic angular frequency son, to establish a new signal SMS(t) for transmitting, wherein, SMS(t)=Sin(pw₀t)×SM(t)+Sin(qw₀t). The transmitted signal SMS(t) is continuous without interruptions because of the synchronous signal being mixed and transmitted simultaneously with the main data signal, and the values of the transmitted signal being zero at the boundaries of each time period. The plurality of signals can be correctly separated at the receiving end. In additions, within the frequency range

$$( {A}_{i} \frac{{T}_{1}}{v} Hz ∼ ( {A}_{i} \frac{{T}_{1}}{v} + \frac{{T}_{1}}{2 v} ) Hz )$$

of the linearly independent signal ᵢaⱼ(t), appropriate intervals are placed between consecutive ᵢaⱼ(t) to simplify the subsequent processing.

Follows are embodiments of this invention including detail descriptions of the basic principle, processing methods and the possible outcome.

I. The basic principles of the mixing techniques at the transmitting end.

(1) Methods described in Pat. 224

A plurality of signals Sᵢ(t) is received within a time period [T₀,T₁], wherein i=1,2, . . . m, m is a positive integer, t is a time variable and tε[T₀,T₁].

Sᵢ(tⱼ), j1,2, . . . n, are samples which have been sampled from the corresponding Sᵢ(t) within time period [T₀,T₁].

Sᵢ(t) are multiplied by the corresponded predetermined m×n sets of the linearly independent function groups ᵢaⱼ(t) to established m sets of transformed signal Sᵢ⁰(t). Sᵢ⁰(t) can be mathematically represented as:

$${S}_{i}^{0} ( t ) = {\sum }_{j = 1}^{n} [ {}_{i}^{}{a}{}_{j}^{} ( t ) {S}_{i} ( {t}_{j} ) ]$$

i=1,2, . . . m

The m sets of the transformed signal S⁰ᵢ(t) are summed to obtain a preliminary mixed signal SM(t). This procedure is mathematically represented as:

$$S M ( t ) = {\sum }_{i = 1}^{m} {S}_{i}^{o} ( t ) ; \qquad < formula 1 >$$

In Pat. 224, SM(t) is the signal to be transmitted to the receiving end.

(2) In this invention, we provide an embodiment which can advance the mixing technique as revealed in Pat. 224.

Let T₀ to be zero and the basic angular

$${w}_{0} = \frac{2 π}{{T}_{1}} .$$

The signal transmitted to the receiving end is:

SMS(t)=Sin(pw₀t)×SM(t)+Sin(qw₀t) <formula 2>

Wherein

$$P = \frac{r + 1}{2} ,$$

r can be a positive integer or zero; q can be

$$\frac{1}{2}$$

or 1.

In formula 2, the values of signal SMS(t) are zero at the boundaries of every time period [0,T₁]. Therefore, interruptions as described in Pat. 224 will not happen. In other words, interruption cancellation signal Sin(pw₀t) can ensure the value of SMS(t) to be zero at both the starting and ending points of each time period .

In formula 2, the synchronous signal Sin(qw₀t) is served as a discriminating signal for discriminating each of the time periods. The precise point within each time period can be known by checking the value of signal Sin(qw₀t). The method for precisely extracting signal Sin(qw₀t) out of the mixed signals is presented else where in this document. If

$$q = \frac{1}{2} ,$$

every half cycle of Sin(qw₀t) represents the point of finishing the previous time period and starting the subsequent time period. Whereas, if q=1, every full cycle of Sin(qw₀t) represents the point of finishing the previous time period and starting the following time period.

An embodiment of this mixing technique requires the following hardware:

At least a receiving unit, for receiving the signal Sᵢ(t);

Several A/D converters, for sampling and digitizing the signal Sᵢ(t);

Several signal generators, for generating signal ᵢaⱼ(t);

Several first multipliers, for calculating the product of Sᵢ(tⱼ)×ᵢa(t), wherein, Sᵢ(tⱼ) is the j^{th} sample of Sᵢ(t);

At least a first adder, for calculating

$$SM ( t ) = {\sum }_{i = 1}^{m} {S}_{i}^{o} ( t ) ;$$

A synchronous signal generator, for generating a synchronous signal sin(w₀t) within the time period [T₀,T₁];

At least a second multiplier and a second adder, calculating SMS(t)=Sin(pw₀t)×SM(t)+Sin(qw₀t)

And a transmitter transmitting the processed mixed signal SMS(t).

(3) The second embodiment illustrates a better method to select ᵢaⱼ(t) in compared with that in Pat. 224.

This mixing technique can mix sound signals and comprise three steps:

Step 1: Selecting the frequency range of ᵢaⱼ(t) to be between

$${A}_{i} \frac{{T}_{1}}{v} Hz ∼ ( {A}_{i} \frac{{T}_{1}}{v} + \frac{{T}_{1}}{2 v} ) Hz ,$$

wherein, A1 are positive integers including zero;

In other words, the frequency range of ᵢaⱼ(t) is between

$${A}_{1} \frac{{T}_{1}}{v} Hz ∼ ( {A}_{1} \frac{{T}_{1}}{v} + \frac{{T}_{1}}{2 v} ) Hz ,$$

the frequency range of ₂aⱼ(t) is between

$${A}_{2} \frac{{T}_{1}}{v} Hz ∼ ( {A}_{2} \frac{{T}_{1}}{v} + \frac{{T}_{1}}{2 v} ) Hz ,$$

and so forth; wherein, v is a positive integer.

Step 2: In formula 1, obtaining v samples from SM(tₛ) (s=1,2, . . . v).

Step 3: Selecting additional v sets of function groups bᵥ(t) which are linear independent within the time period [0,T₁], establishing TSM(t) by formula 3:

$$TSM ( t ) = {\sum }_{s = 1}^{v} [ SM ( {t}_{s} ) {b}_{s} ( t ) ] \qquad < formula 3 >$$

Step 4: In order to mix the synchronous signal and eliminate possible interruptions at the boundaries of each time period, the actual signal received by the receiving unit is TSMS(t) which can be mathematically represented as:

TSMS(t)=sin(pw₀t)TSM+sin(qw₀t) <formula (3)-1>

Wherein, p=(r+1)/2 , r can any positive integers including zero, q can be ½ or 1, and w₀=2π/T₁ .

In the second embodiment of this invention, the amount of transmitted data is increased within a limited bandwidth.

This second embodiment requires the following hardware:

m sets of A/D converters, for sampling and digitizing signal Sᵢ(t);

m×n signal generators, for generating signal ᵢaⱼ(t), wherein, the frequency range of the signal ᵢaⱼ(t) is

$${A}_{i} \frac{{T}_{1}}{v} Hz ∼ ( {A}_{i} \frac{{T}_{1}}{v} + \frac{{T}_{1}}{2 v} ) Hz ,$$

v=1,2, . . . m,;

m×n first multipliers, for calculating the product function of Sᵢ(tᵢ)×ᵢaⱼ(t), wherein, Sᵢ(tᵢ) is the j^{th} sample of the signal S(t);

At least a first adder, for calculating

$$SM ( t ) = {\sum }_{i = 1}^{m} {S}_{i}^{o} ( t ) ; ;$$

A synchronous signal generator, for generating synchronous signal sin(w₀t) within the time period [T₀,T₁];

At least a converter, for sampling v samples from signal SM(t);

Several third signal generators, for generating v sets of linearly independent function groups bₛ(t);

At least a second multiplier and a second adder, for calculating the transformed signal TSM(t) of the signal SM(tₛ);

At least a second multiplier and a second adder, for calculating the mixed signal TSMS(t); and,

A transmitter transmitting processed mixed signal SMS(t).

II. Basic principles of separating the mixed signal at the receiving end:

(1) Basic principle 1—solving homogenous ordinary difference equations The solution of formula (4) is yₖ=c₁cos kθᵢ+c₂sin kθᵢ, wherein c₁ and c₂ are any constants.

yₖ₋₂−2cos θᵢ yₖ₋₁+yₖ=0 <formula (4)>

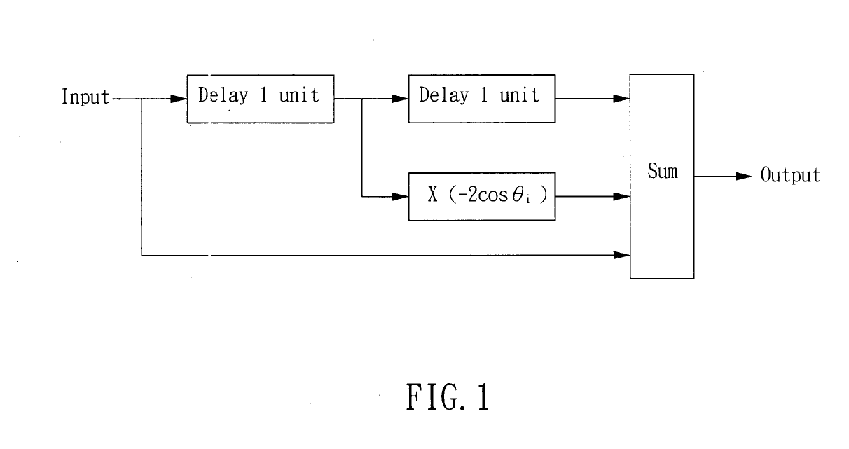

This behaves like a single frequency filter. Descriptions are provided in the circuit blocks of FIG. 1. Hence, if the frequency of a signal is θᵢ, the value of this signal will become zero and be filtered out. By gradually varying the value of θᵢ, unwanted signals can filtered out. An embodiment of formula 4 is described by the circuit blocks of FIG. 1. If the input is c₁ cos kθᵢ+c₂ sin kθᵢ, the output is zero. In other words, input signals which contain angular frequency θᵢ are filtered out.

Utilizing S to represented the difference operator so that formula 4 can be modified as formula (4)-1.

(S⁻²−2cos θᵢS⁻¹+S⁰)yₖ=0 <formula (4)-1>

Formula 5 represents a difference equation of forth order

(S⁻²−2cos θᵢS⁻¹+S⁰)(S⁻²−2cos θ₂S⁻¹+S⁰)yₖ=0 <formula (5)>

Formula (5) can also be represented as:

[S⁻⁴−2(cos θ₁+cos θ₂)S⁻³+(4cos θ₁ cos θ₂+2)S⁻²−2(cos θ₁+cos θ₂)S⁻¹+S⁰]yₖ=0

Thus:

yₖ₋₄−2(cos θ₁+cos θ₂)yₖ₋₃+(4cos θ₁ cos θ₂+2)yₖ₋₂−2(cos θ₁+cos θ₂)yₖ₋₁+yₖ=0 <formula(5)-1>

The solutions of the formula (5)-1 is yₖ=coskθᵢ+c₂sink θᵢ+c₃coskθ₂+c₄sink θ₂; c₁, c₂, c₃ and c₄ are constants.

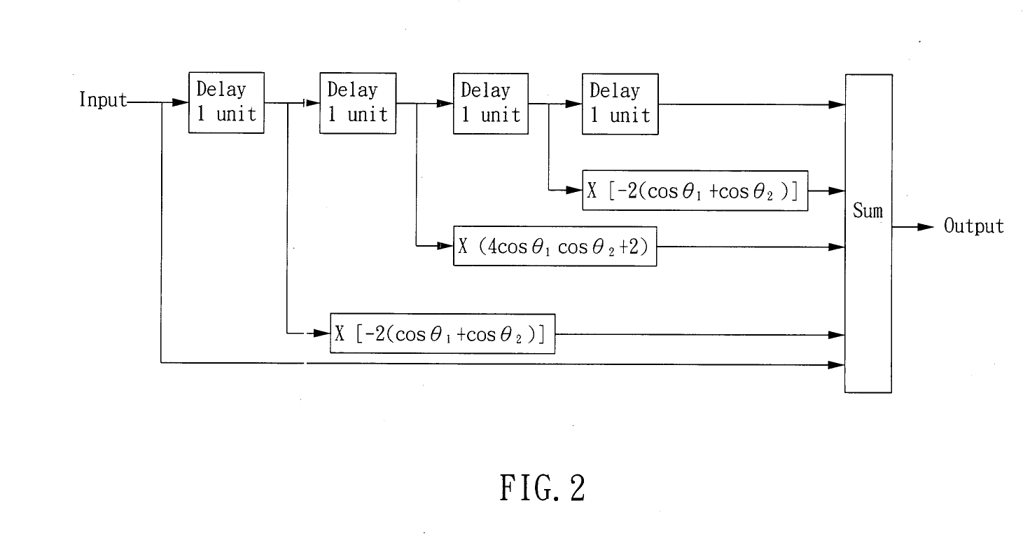

An embodiment of formula 5 is described by the circuit blocks of FIG. 2, wherein, input signals which contain the angular frequencies θ₁ and θ₂ are filtered out.

Formula 6 is a ordinary difference equation of 2(n−1)^{th} order.

$$[ {\prod }_{i = 1}^{u - 1} ( {S}^{- 2} - 2 cos {θ}_{i} {S}^{- 1} + 1 ) \cdot {\prod }_{i = u + 1}^{n} ( {S}^{- 2} - 2 cos {θ}_{i} {S}^{- 1} + 1 ] {y}_{k} = 0 \qquad < formula ( 6 ) >$$

Formula (6) can be modified into formula (6)-1.

Lᵤ(S)yₖ=0 <formula (6)-1>

Wherein:

$${L}_{u} ( s ) = {\prod }_{i = 1}^{u - 1} ( {S}^{- 2} cos {θ}_{i} {S}^{- 1} + 1 ) \cdot {\prod }_{i = u + 1}^{n} ( {S}^{- 2} - 2 cos {θ}_{i} {S}^{- 1} + 1 )$$

, n are positive integers.

Formula (6) and formula (6)-1 can further be modified into formula (6)-2:

aᵤ(2n−2)yₖ₋₂ₙ₊₂+aᵤ(2n−3)yₖ₋₂ₙ₊₃+aᵤ(2n−5)yₖ₋₂ₙ₊₄+ . . . +aᵤ(1)yₖ₋₁+aᵤ(0)yₖ=0 <formula (6)-2>

Wherein, aᵤ(v), v=0, 1, . . . 2n−2, are the coefficients of S^{-v} after development of Lᵤ(S).

Because both aᵤ(2n−2) and aᵤ(0) are equal 1, formula (6)-2 can be modified into formula (6)-3:

yₖ₋₂ₙ₊₂+aᵤ(2n−3)yₖ₋₂ₙ₊₃+aᵤ(2n−4)yₖ₋₂ₙ₊₄+ . . . +aᵤ(1)yₖ₋₁+yₖ=0 <formula (6)-3>

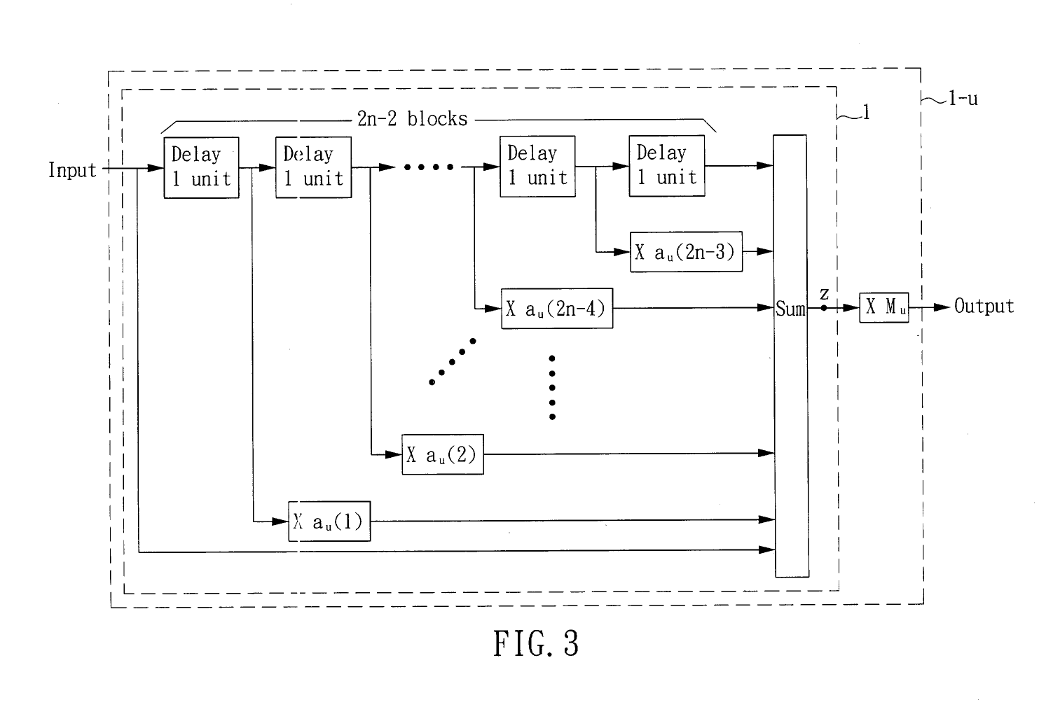

The circuit blocks of FIG. 3 represented an embodiment of formula (6)-3.

The solution of formula (6)-3 is:

$${y}_{k} = {\sum }_{i = 1}^{u - 1} ( {C}_{i} cos k {θ}_{i} + {b}_{i} sin k {θ}_{i} + {\sum }_{i = u + 1}^{n} ( {C}_{i} cos {θ}_{i} + {b}_{i} sin k {θ}_{i} )$$

; Cᵢ and bᵢ are constants.

Therefore, in FIG. 3, if the input signals are

$${\sum }_{i = 1}^{n} ( {A}_{i} cos k {θ}_{i} + {B}_{i} sin k {θ}_{i} ,$$

all signals will be filtered out at point z of FIG. 3 except Aᵤcosk θᵤ+Bᵤsink θᵤ. The value of Mu is

$${M}_{u} = \frac{1}{2 \cdot {\prod }_{i = 1}^{u - 1} ( cos {θ}_{u} - cos {θ}_{i} )} \cdot \frac{1}{{\prod }_{i = u + 1}^{n} ( cos {θ}_{u} - cos {θ}_{i} )} \qquad < formula ( 7 ) >$$

At point z, because signal Aᵤ^{cos}kθᵤ+Bᵤ^{sin}kθᵤ is diminished to be

$$\frac{1}{{M}_{u}}$$

of the original, it has to be multiplied by Mᵤ to be the actual output.

An embodiment of the basic principle 1 for separating the mixed signal at the receiving end requires the following hardware:

A receiving unit, for receiving processed mixed signals:

At least a sampling unit, for sampling 2n−1 samples from the processed mixed signal and the 2n−1 samples being mathematically represented as: yₖ₋₂ₙ₊₂, yₖ₋₂ₙ₊₃, . . . yₖ;

A signal generator, for generating 2n−3 pre-determined constant coefficients, aᵤ(1), aᵤ(2), . . . aᵤ(2n−3); and

several multipliers and adders, for producing the following output signals:

[yₖ₋₂ₙ₊₂+aᵤ(2n−3)yₖ₋₂ₙ₊₃+aᵤ(2n−4)yₖ₋₂ₙ₊₄+ . . . +aᵤ(1)yₖ₋₁+yₖ]*Mᵤ,

wherein,

$${M}_{u} = \frac{1}{2 \cdot {\prod }_{i = 1}^{u - 1} ( cos {θ}_{u} - cos {θ}_{i} )} \cdot \frac{1}{{\prod }_{i = u + 1}^{n} ( cos {θ}_{u} - cos {θ}_{i} )} ∘$$

(2) Basic principle 2—solving the homogeneous ordinary differential equations:

Formula 8 is a homogeneous ordinary differential equation.,

$$( {D}^{2} + {w}_{i}^{2} ) y ( t ) = 0 \qquad < formula ( 8 ) >$$

The solution of formula 8 is y(t)=C₁cos wᵢt+C₂sin wᵢt; C₁ and C₂ are constants.

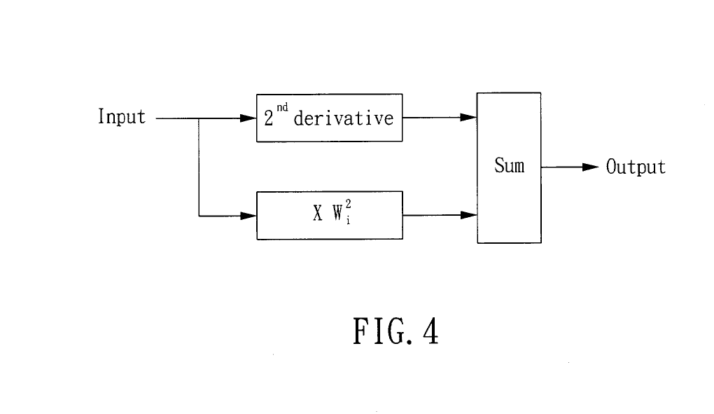

An embodiment of formula 8 is presented in the circuit blocks of FIG. 4. Input signals which contain angular frequency wᵢ are filtered out.

Formula 9 is ordinary differential equation of 2(n−1)^{th} order.

$$[ {\prod }_{i = 1}^{u - 1} ( {D}^{2} + {w}_{i}^{2} ) {\prod }_{i = u + 1}^{n} ( {D}^{2} + {w}_{i}^{2} ) ] y ( t ) = 0 \qquad < Formula ( 9 ) >$$

Formula (9) can be represented as formula (9)-1:

[D²ⁿ⁻¹+αᵤ(n−2)D²ⁿ⁻⁴+αᵤ(n−3)D²ⁿ⁻⁶+ . . . +αᵤ(1)D²+1]y(t)=0 <formula (9)-1>

wherein, αᵤ(j) are the coefficients of D^{2n-2j}, j=1,2, . . . , n−2 after development of

$${\prod }_{i = 1}^{u - 1} ( {D}^{2} + {w}_{i}^{2} ) {\prod }_{i + u + 1}^{n} ( {D}^{2} + {w}_{i} ) .$$

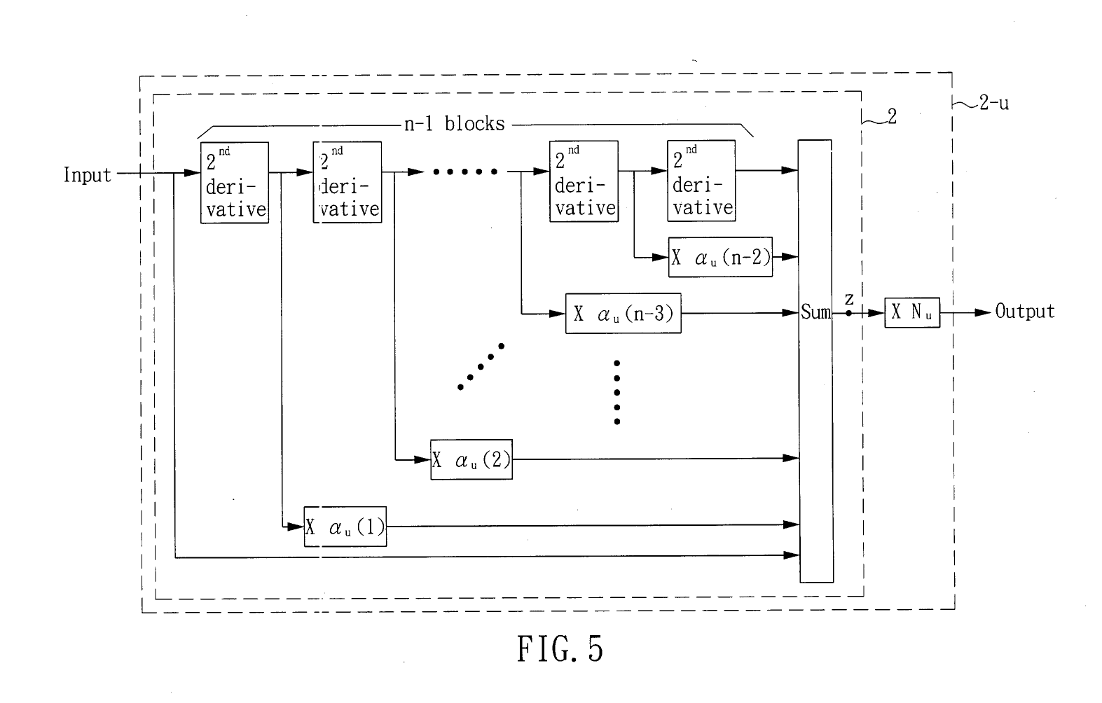

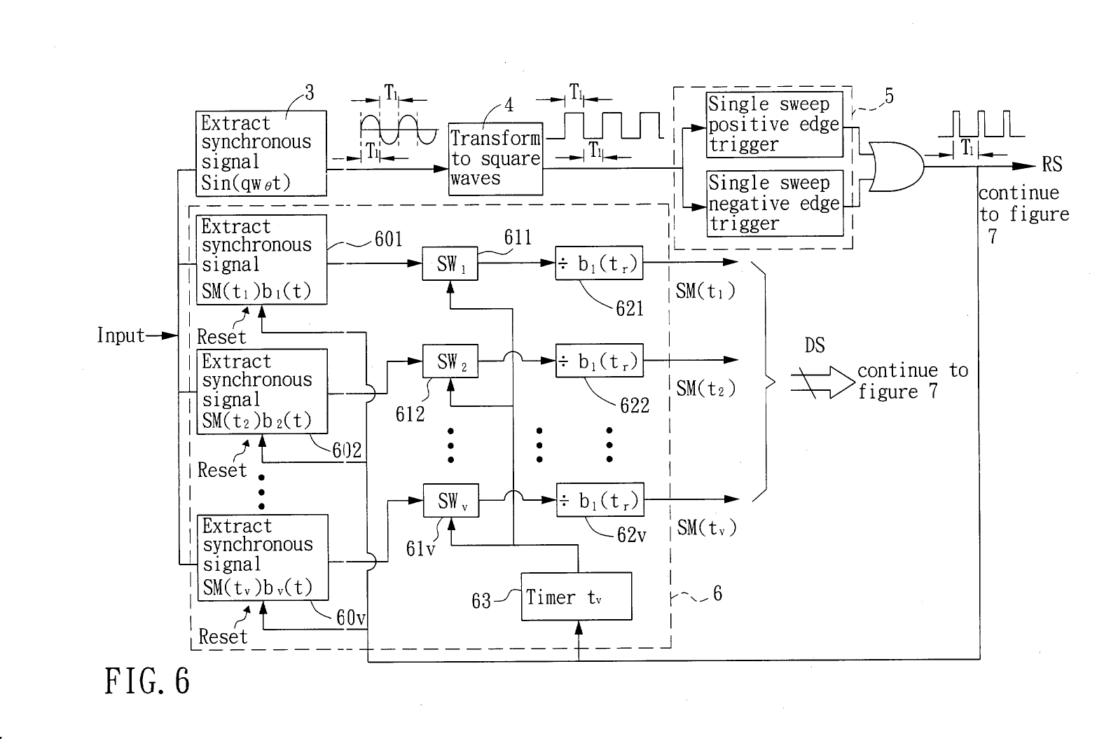

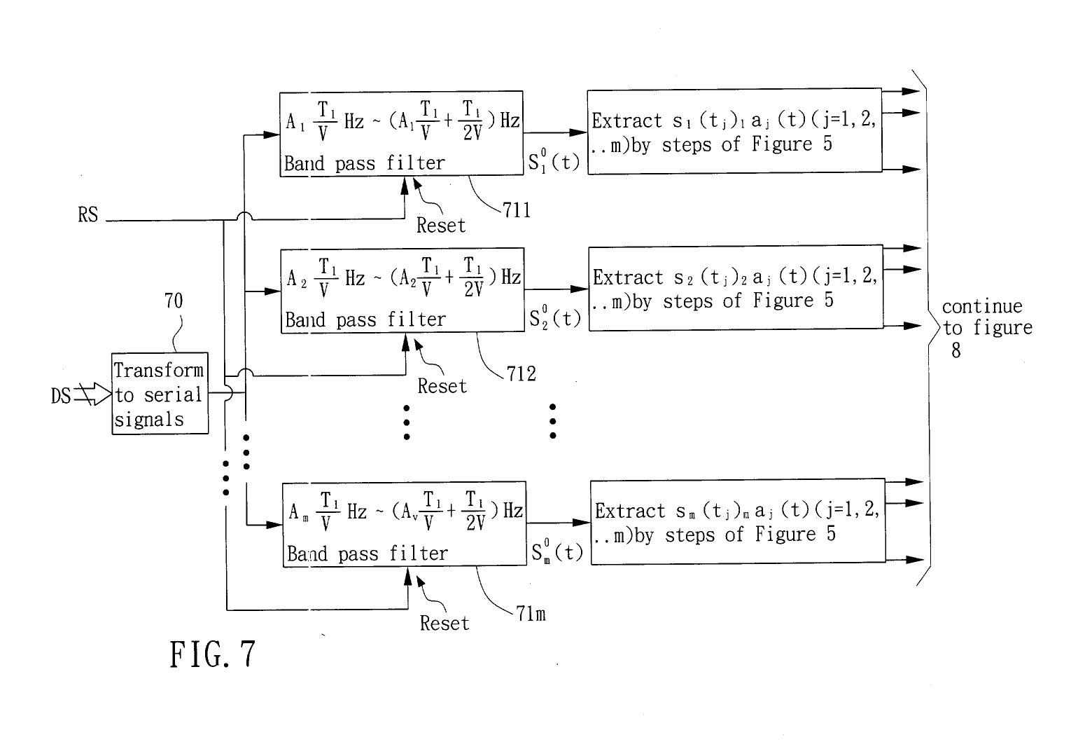

Circuit blocks of FIG. 5 represent an embodiment of formula (9)-1. In FIG. 5, after inputting signal

$${\sum }_{i = 1}^{n} ( {C}_{i} cos {w}_{i} t + {d}_{i} sin {w}_{i} t ) ,$$

all signals will be filtered out at point z, except Cᵤ cos wᵤt+dᵤ sin wᵤt, wherein, Cᵢ and dᵢ are constants.

The value of Nᵤ is represented in formula 10.

$${N}_{u} = \frac{1}{{\prod }_{i = 1}^{u - 1} ( - {w}_{u}^{2} + {w}_{i}^{2} )} * \frac{1}{{\prod }_{i + 1}^{n} ( - {w}_{u}^{2} + {w}_{i}^{2} )} \qquad < formula ( 10 ) >$$

At the point z of FIG. 5, signal Cᵤ cos wᵤt+dᵤ sin wᵤt is diminished to be

$$\frac{1}{{N}_{u}}$$

of the original. Therefore, the signal Cᵤ cos wᵤt+dᵤ sin wᵤt has to be multiplied by N, to be the actual output.

An embodiment of the basic principle 2 for separating the mixed signal at the receiving end requires the following hardware:

A receiving unit, for receiving processed mixed signal;

Several differentiators, for calculating derivatives of the received processed mixed signal and obtaining the following values: D²ⁿ⁻² y(t), D²ⁿ⁻⁴ y(t), . . . D² y(t) l wherein, D^{x} y(t) represented the x^{th} derivative of y(t);

A signal generator, for generating n−2 pre-determined constant coefficients, αᵤ(1), αᵤ(2), . . . αᵤ(n−2); and

Several multipliers producing following output signals:

[D²ⁿ⁻¹+αᵤ(n−2)D²ⁿ⁻⁴+αᵤ(n−3)D²ⁿ⁻⁶+ . . . +αᵤ(1)D²+1]*Nᵤ,

wherein, αᵤ(j) are the coefficients of D^{2n-2j}, j=1,2, . . . , n−2, after development of

$${\prod }_{i = 1}^{u - 1} ( {D}^{2} + {w}_{i}^{2} ) {\prod }_{i + u + 1}^{n} ( {D}^{2} + {w}_{i} ) ; and , {N}_{u} = \frac{1}{{\prod }_{i = 1}^{u - 1} ( - {w}_{u}^{2} + {w}_{i}^{2} )} * \frac{1}{{\prod }_{i + 1}^{n} ( - {w}_{u}^{2} + {w}_{i}^{2} )} .$$

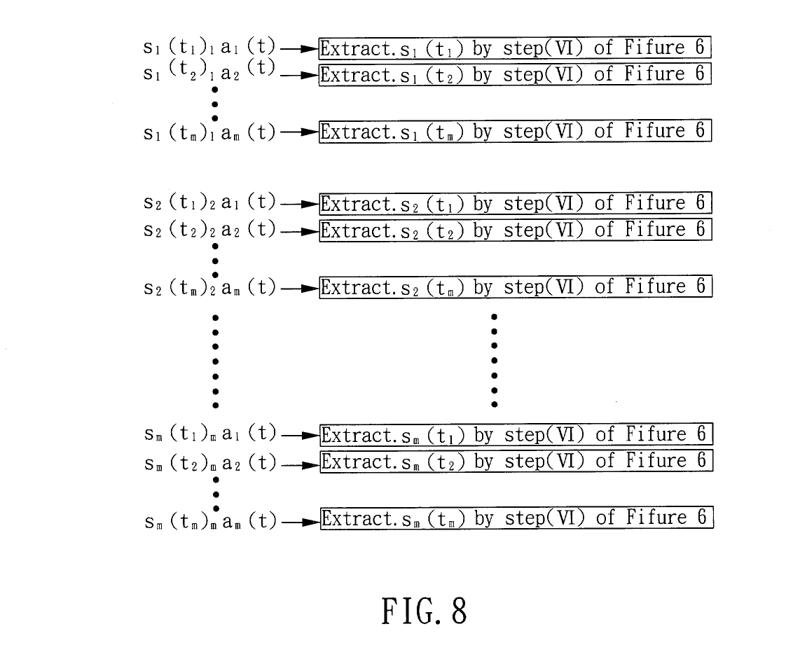

(3) Basic principle 3—There are 6 steps for separating signals which coupled with the signal mixing techniques described above. An embodiment is illustrated in the circuit blocks of FIG. 6, FIG. 7, and FIG. 8.

Step 1: selecting ᵢaⱼ(t) which contain either pure sin (wᵢⱼt) or pure cos (wᵢⱼt) sinusoidal signal, wherein, all wᵢⱼ are different positive integers.

Step 2: If c=½. extracting the synchronous signal sin (qw₀t) from TSM(t) of formula 3 by the method described in FIG. 5. The steps of extracting the synchronous signal are presented in (3), (4), and (5) of FIG. 6.

Step 3: In formula (3), TSM(t) contains angular frequency qw₀, |pw₀±wₛ| (s=1,2, . . . v). Using the methods described in FIG. 5, extracting signals SM(t₁)b₁(t), SM(t₂)b₂(t), . . . SM(tᵥ)bᵥ(t) individually. Detail steps of extracting these signals are presented ill 601˜60 v of FIG. 6.

Step 4: tᵣ is selected within the time period [T₀,T₁]. Each of the bₛ(tᵣ) (s=1,2, . . . v) is divided by the corresponding bₛ(tᵣ) to obtain SM(t₁), SM(t₂), . . . SM(tᵥ). These procedures are presented in 621-622- . . . 62 v of FIG. 6. Before extracting the SM(tₛ) (s=1,2, . . . v), timer 63 outputs a pulse at the time when t=tᵣ and the switch SWₛ (s=1,2, . . . v) is turned ON. The output of 601-602- . . . 60 v circuit blocks are fed into dividers 621-622- . . . 62 v, in respectively. The embodiment of this divider can be a resistance voltage divider.

Step 5: 711˜71 m of FIG. 7 is utilizing general sampling theory. step 6: as described in FIG. 8.

III. Illustration of a simple embodiment

(1) at the transmitting aspect:

1. In formula (1), letting n=8 and m=5;

$$\begin{matrix}{S}_{i}^{0} ( t ) = {\sum }_{j = 1}^{n} [ {}_{i}^{}{a}{}_{j}^{} ( t ) {S}_{i} ( {t}_{j} ) ] \\ SM ( t ) = {\sum }_{i = 1}^{m} {S}_{i}^{o} ( t ) ;\end{matrix}$$

2. letting T₀=0 and T₁=10⁻³, thus, w₀=2000π; in formula 2, letting p=q=½

3. selecting five different sound signals, Sᵢ(t), t=1,2,3,4,5;

4. letting w(u)=2[300+130(u−1)]π, selecting:

$$\begin{matrix}{}_{i}^{}{a}{}_{j}^{} ( t ) = cos [ w ( i * \frac{j + 1}{2} ) t ] ( if j are odd numbers ) ; \\ {}_{i}^{}{a}{}_{j}^{} ( t ) = sin [ w ( i * \frac{j}{2} ) t ] ( if j are even numbers )\end{matrix} \qquad < formula ( 11 ) >$$

Thus, SMS(t) of formula (2) is presented as:

$$\begin{matrix}SMS ( t ) = sin ( 1000 π t ) {\sum }_{i = 1}^{5} {\sum }_{j = 1}^{8} {S}_{i} ( {t}_{i} ) {}_{i}^{}{a}{}_{j}^{} ( t ) + sin ( 1000 π t ) & < formula ( 12 ) > \\ Wherein , & \\ {\sum }_{i = 1}^{5} {\sum }_{j = 1}^{8} {S}_{i} ( {t}_{i} ) {}_{i}^{}{a}{}_{j}^{} ( t ) + sin ( 1000 π t ) = & < formula ( 12 ) \text{-} 1 > \\ {\sum }_{i = 1}^{5} [ {S}_{i} ( {t}_{1} ) cos ( w ( i ) t ) + {S}_{i} ( {t}_{2} ) sin ( w ( i ) t ) + & \\ {S}_{i} ( {t}_{3} ) cos ( w ( 2 i ) t ) + … + {S}_{i} ( {t}_{8} ) sin ( w ( 4 i ) t ) ] = & \\ {S}_{1} ( {t}_{1} ) cos ( 600 π t ) + {S}_{1} ( {t}_{2} ) sin ( 600 π t ) + … + & < formula ( 12 ) \text{-} 2 > \\ {S}_{1} ( {t}_{8} ) sin ( 1380 π t ) + {S}_{2} ( {t}_{1} ) cos ( 1640 π t ) + & \\ {S}_{2} ( {t}_{2} ) sin ( 1640 π t ) + … + {S}_{2} ( {t}_{8} ) sin ( 2420 π t ) + & \\ {S}_{3} ( {t}_{1} ) cos ( 2680 π t ) + {S}_{3} ( {t}_{2} ) sin ( 2680 π t ) + … + & \\ {S}_{3} ( {t}_{8} ) sin ( 3460 π t ) + {S}_{4} ( {t}_{1} ) cos ( 3720 π t ) + & \\ {S}_{4} ( {t}_{2} ) sin ( 3720 π t ) + … + {S}_{4} ( {t}_{8} ) sin ( 4500 π t ) + & \\ {S}_{5} ( {t}_{1} ) cos ( 4760 π t ) + {S}_{5} ( {t}_{2} ) sin ( 4760 π t ) + … + & \\ {S}_{5} ( {t}_{8} ) sin ( 5540 π t ) & \end{matrix}$$

Therefore, formula 12 contains angular frequencies (1000±600)π, (1000±860)π, (1120±1000)π, . . . (5540±1000)π and 1000π. Except for the sinusoidal signal, sin(1000πt), which is served as the synchronous signal, all others signals have the same amplitude as that of the original sound signals. For example, the amplitude of cos[(1000±600)πt] is S₁(t₁); the amplitude of sin[(1000±600)πt] is S₁(t₂), . . . , and the amplitude of sin[(5540±1000)πt] is S₅(t₈)°

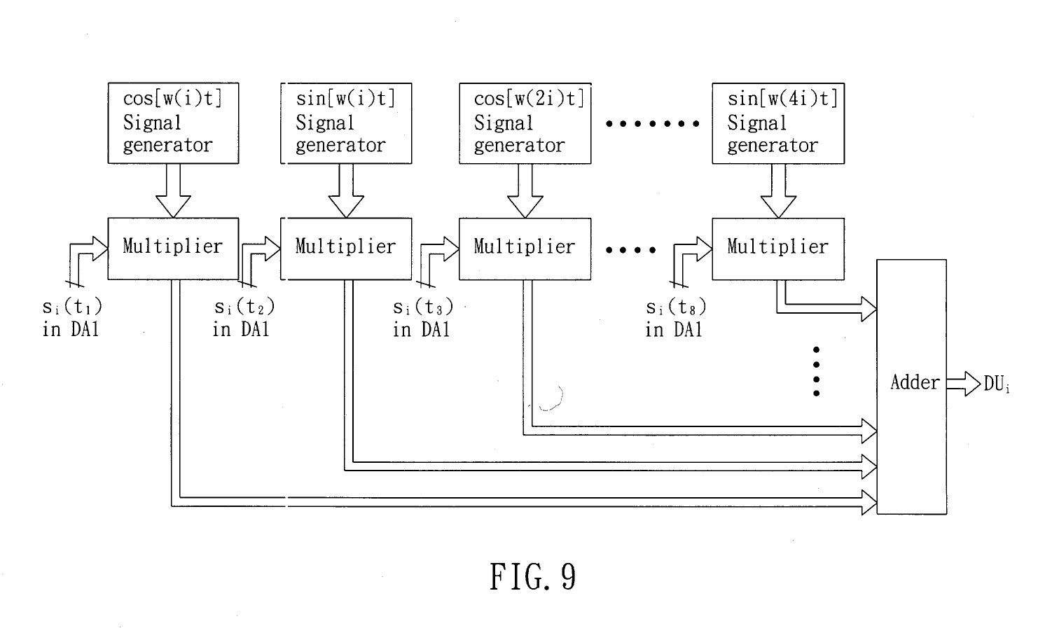

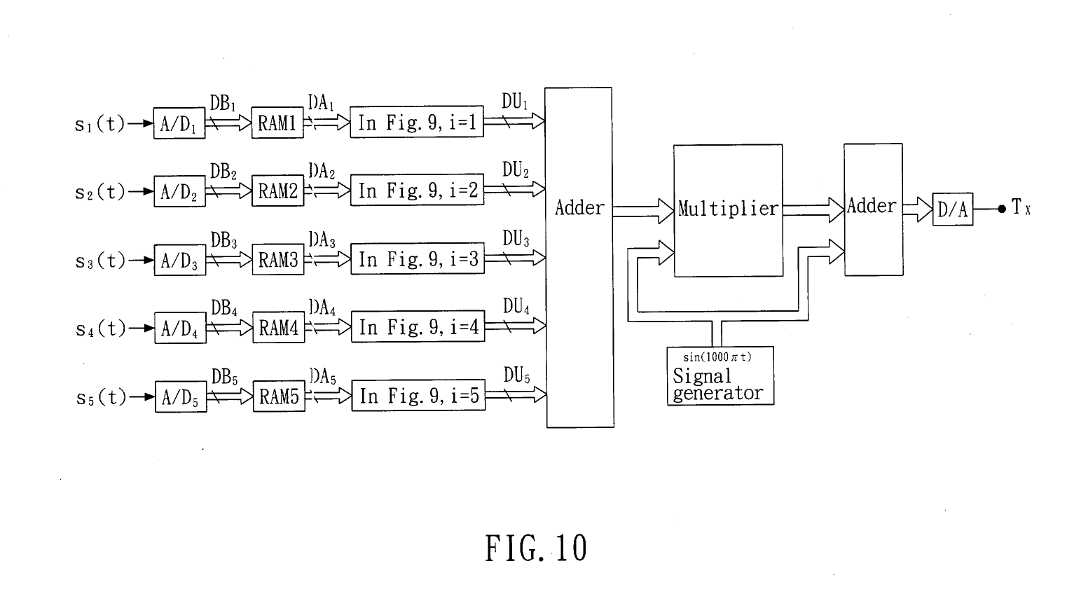

5. FIG. 9 and FIG. 10 demonstrate an embodiment of formula (12) for the transmitting end. Wherein, the transmitting signal Tx of FIG. 10 represents the signal SMS(t) which is the actual signal to be transmitted from the transmitting end. Because the details of mixing techniques have been described previously in this invention, the purpose of this embodiment is merely to provide a uncomplicated example. More detail illustrations can also be referred to FIG. 9 and FIG. 10.

(2) at the receiving aspect:

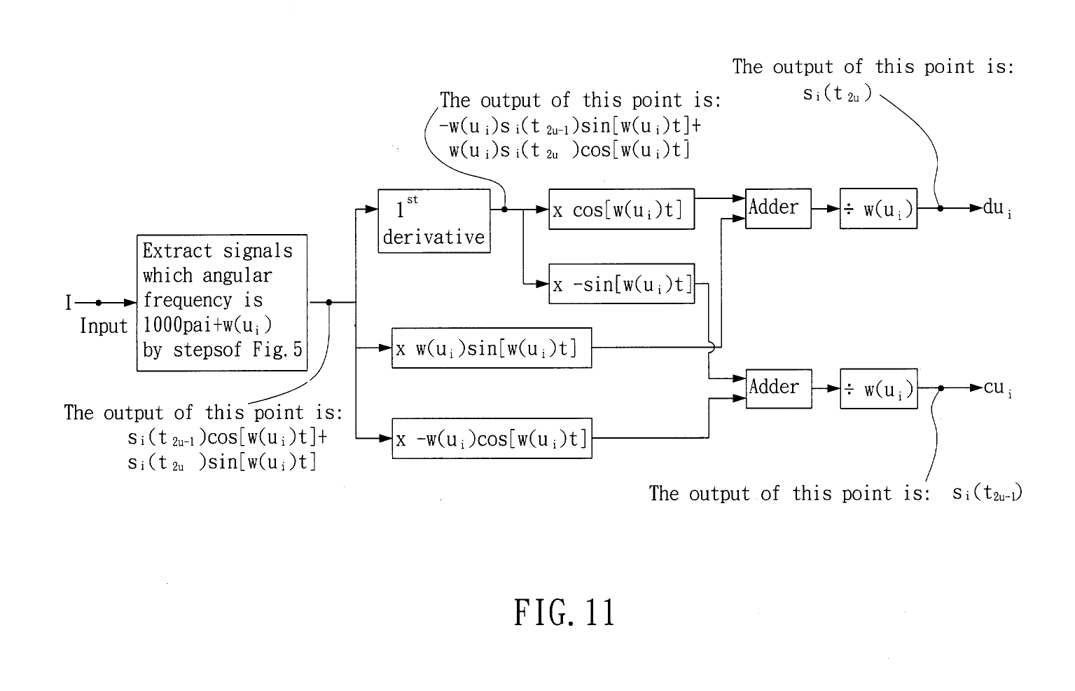

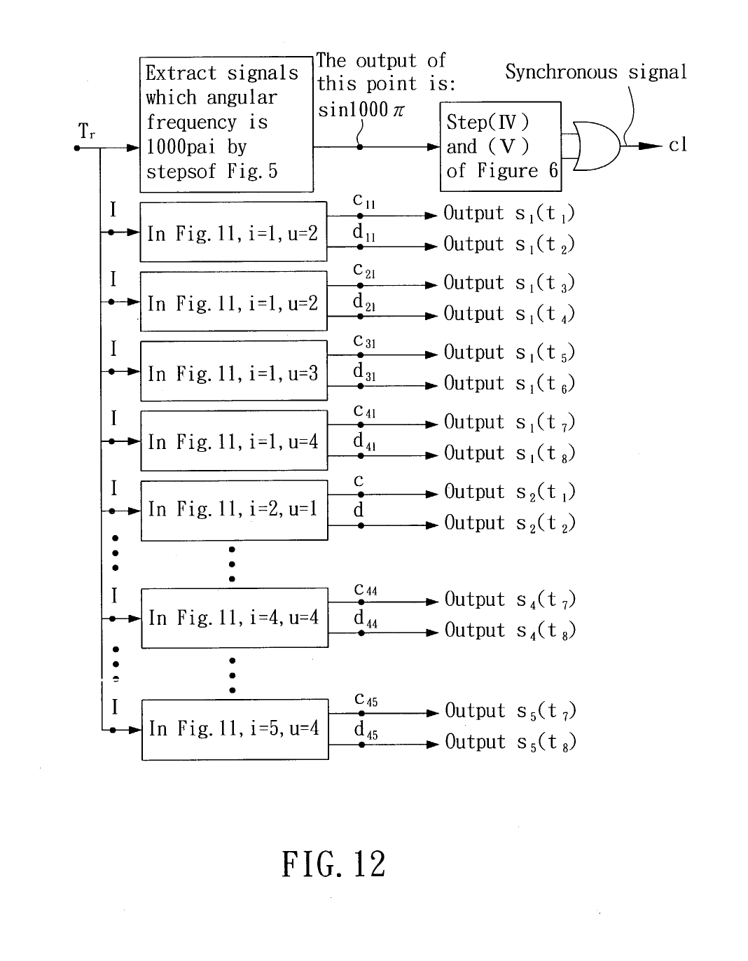

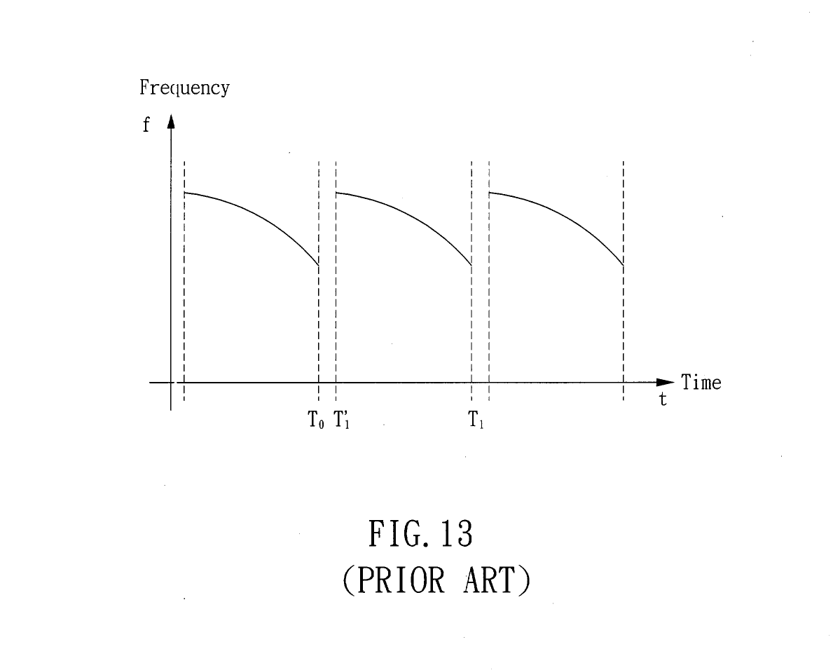

The circuit blocks of FIG. 11 and FIG. 12 demonstrate in embodiment at the receiving end. Tr of FIG. 12 is the input signal received from the transmitting end. cl is the output of synchronous signal which re-sets all the circuit blocks. Because the details of mixing techniques have been described previously in this invention, the purpose of this embodiment is merely to provide a uncomplicated example. More detail illustrations can also be referred to FIG. 11 and FIG. 12.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined ill the appended claim.

What the claim is:

1. a method for processing a plurality of signals, comprising the steps of:
(a). receiving a plurality of analog signals Sᵢ(t) within a time period [T₀,T₁], wherein i=1,2, . . . m, m is positive integer, t is time variable and tε[T₀,T₁]; T₀, T₁ εR;
(b). Sampling said plurality of analog signals Sᵢ(t) within said time period ε[T₀,T₁] and obtaining n samples Sᵢ(tⱼ) for each analog signal, wherein j=1,2, . . . n, n is positive integer, tⱼ ε[T₀,T₁];
(c). Selecting m×n predetermined linearly independent groups ᵢaⱼ(t) and producing a transformed signal S⁰ⱼ(t), said transformed signal S⁰ᵢ(t) can be mathematically represented as
$${S}_{i}^{0} ( t ) = {\sum }_{j = 1}^{n} [ {}_{i}^{}{a}{}_{j}^{} ( t ) {S}_{i} ( {t}_{j} ) ]$$
(d). summing all said transformed signal S⁰ᵢ(t) and establishing a first mixed signal SM(t) which can be mathematically represented as
$$SM ( t ) = {\sum }_{i = 1}^{m} {S}_{i}^{o} ( t ) ;$$
and
(e). selecting a predetermined synchronous signal sin(w₀t) and generating a second mixed signal SMS(t) which can be represented as SMS(t)=Sin(pwₒt)×SM(t)+Sin(qwₒt);
Wherein w₀ is basic angular frequency and w₀, p, qεR, tε[T₀,T₁], sin(pw₀t) is an interruption cancellation signal which can zeroing the initial value of each of the time pulse of said second mixed signal SMS(t), and said second mixed signal SMS(t) can become a continuous and interruption-free signal.

2. The method as in claim 1, wherein
$$P = \frac{r + 1}{2} ,$$
q can be either ½ or 1 and
$${w}_{0} = \frac{2 π}{{T}_{1}} .$$

3. The method as in claim 1, further comprising:
According to said predetermined linearly independent group ᵢaⱼ(t) and said predetermined synchronous signal sin(w₀t), obtaining 2n−3 constant coefficients aᵤ(1), aᵤ(2), . . . aᵤ(2n−3) via resolving homogeneous ordinary difference equations;
sampling said received second mixed signal SMS(t) and acquiring one sample from each of the fixed time delay and obtaining total of 2n−1 samples, said 2n−1 samples can be mathematically represented as: yₖ₋₂ₙ₊₂, yₖ₋₂ₙ₊₃, . . . yₖ; and
processing said 2n−1 samples to obtain said proposed synchronous signal, said processing method can be mathematically represented as:
[yₖ₋₂ₙ₊₂+aᵤ(2n−3)yₖ₋₂ₙ₊₃+aᵤ(2n−4)yₖ₋₂ₙ₊₄+ . . . +aᵤ(1)yₖ₋₁+yₖ]* Mᵤ,
wherein,
$${M}_{u} = \frac{1}{2 \cdot {\prod }_{i = 1}^{u - 1} ( cos {θ}_{u} - cos {θ}_{i} )} \cdot \frac{1}{{\prod }_{i = u + 1}^{n} ( cos {θ}_{u} - cos {θ}_{i} )} .$$

4. The method as in claim 1 further comprising steps for extracting a proposed synchronous signal from said second mixed signal SMS(t):
solving said predetermined linearly independent group ᵢaⱼ(t) and said predetermined synchronous signal sin(w₀t) with homogeneous ordinary differential equation method and obtaining n−2 values of constant coefficients αᵤ(1), αᵤ(2), . . . αᵤ(n−2);
In a time period, received said second mixed signal SMS(t) is mathematically represented as y(t), and using 2^{nd} order differentiators to obtain n−1 derivatives of y(t), said n−1 derivatives being able to be represented as D²ⁿ⁻²y(t), D²ⁿ⁻⁴y(t), . . . D²y(t), wherein D^{x}y(t) is the x^{th} derivative of y(t); and
Processing said n−1 derivatives and obtaining said proposed synchronous signal, said processing being mathematically represented as:
[D²ⁿ⁻¹+αᵤ(n−2)D^{2m-4}+αᵤ(n−3)D²ⁿ⁻⁶+ . . . +αᵤ(1)D²+1]*Nᵤ,
wherein αᵤ(j) is the coefficient of D^{2n-2j}, j=1,2, . . . , n−2, after development of
$${\prod }_{i = 1}^{u - 1} ( {D}^{2} + {w}_{i}^{2} ) {\prod }_{i + u + 1}^{n} ( {D}^{2} + {w}_{i} ) , and {N}_{u} = \frac{1}{{\prod }_{i = 1}^{u - 1} ( - {w}_{u}^{2} + {w}_{i}^{2} )} * \frac{1}{{\prod }_{i + 1}^{n} ( - {w}_{u}^{2} + {w}_{i}^{2} )} .$$

5. The method of claim 1, further comprising steps of separating said second mixed signal SMS(t): extracting said synchronous signal sin(qw₀t) by the method of claim 3, said synchronous signal sin(qw₀t) being used as the time controlled signal for subsequent analysis;
separating signals SM(t₁)sin(pw₀t), SM(t₂)sin(pw₀t), . . . SM(tᵥ)sin(pw₀t) which contain said synchronous signal sin (qw₀t) by the method of claim 3.
obtaining SM(t₁), SM(t₂), . . . SM(tᵥ) according to dividing sin(pw₀t) from SM(t₁)sin(pw₀t), SM(t₂)sin(pw₀t), . . . SM(tᵥ)sin(pw₀t) respectively;
transforming said signals SM(t₁), SM(t₂), . . . SM(tᵥ) into serial signals;
because said predetermined linearly independent group ᵢaⱼ(t) is a sinusoidal and synchronous signal, said method in claim 3 can be used to separate each of S₁(tⱼ)ᵢaⱼ(t), S₂(tⱼ)₂aⱼ(t), Sₘ(tⱼ)ₘaⱼ(t), wherein, j=1,2 . . . n; and
dividing each of Sᵢ(tⱼ)ᵢaⱼ(t), S₂(tⱼ)₂aⱼ(t), Sₘ(tⱼ)ₘaⱼ(t) by corresponding ᵢaⱼ(t) in order to obtain Sᵢ(t).

6. The method as in claim 1, further comprising steps for separating said second mixed signal SMS(t):
Using said method in claim 4 to separating said synchronous signal sin(qw₀t) which consequently becomes the controlling signal for the subsequent analysis.
Using said method in claim 4 to separating signal SM(t₁)sin(pw₀t), SM(t₂)sin(pw₀t), . . . SM(tᵥ)sin(pw₀t) which contain said synchronous signal sin(qw₀t),
Obtaining SM(t₁), SM(t₂), . . . SM(tᵥ) according to Dividing sin(pw₀t) from SM(t₁)sin(pw₀t), SM(t₂)sin(pw₀t), . . . SM(tᵥ)sin(pw₀t) in correspondingly;
Transforming said signals SM(t₁), SM(t₂), . . . SM(tᵥ) into serial signals;
Because ᵢaⱼ(t) is a sinusoidal and synchronous signal, said method in claim 4 can be used to obtain S₁(tⱼ)ᵢaⱼ(t), S₂(tⱼ)₂aⱼ(t), Sₘ(tⱼ)ₘaⱼ(t), wherein j=1,2 . . . n; and
Separating Sᵢ(t) according to Dividing ᵢaⱼ(t) from corresponding S₁(tⱼ)ᵢaⱼ(t), S₂(tⱼ)₂aⱼ(t), Sₘ(tⱼ)ₘaⱼ(t).

7. A method for processing a plurality of signals, comprising the steps of: receiving said plurality of analog signals within a time period [T₀,T₁], each of said analog signals being able to be mathematically represented by an equation of Sᵢ(t) within the time period [T₀,T₁], wherein i=1,2, . . . m, m is integer, t is time variable, tε[T₀T, T₁], T₀, T₁εR;
Sampling the analog signals Sᵢ(t) within the time period [T₀,T₁] and obtain n samples for each signal, said samples being mathematically represented by Sᵢ(tⱼ), wherein n is integer, j=1,2, . . . n , tⱼε[T₀,T₁];
selecting m×n predetermined linearly independent group ᵢaⱼ(t), establishing a transformed signal S⁰ⱼ(t) in corresponding to Sᵢ(t), S⁰ᵢ(t) being able to be mathematically represented as:
$${S}_{i}^{0} ( t ) = {\sum }_{j = 1}^{n} [ {}_{i}^{}{a}{}_{j}^{} ( j ) {S}_{i} ( {t}_{j} ) ] ,$$
wherein, the frequency of said ᵢaⱼ(t) is within
$${A}_{i} \frac{{T}_{1}}{v} Hz ∼ ( {A}_{i} \frac{{T}_{1}}{v} + \frac{{T}_{1}}{2 v} ) Hz ,$$
Aᵢ are positive integers including zero;
Summing all said transformed signal S⁰ᵢ(t) to generate a first mixed signal SM(t) which can be mathematically represented as
$$SM ( t ) = {\sum }_{i = 1}^{m} {S}_{i}^{o} ( t ) ;$$
sampling said first mixed signal SM(t) within the time period [T₀,T₁], and obtaining v samples, said v samples being mathematically represented as SM(tₛ), wherein s=1,2, . . . v, and
selecting v predetermined linearly independent groups bₛ(t) and generating a transformed signal SM(tₛ) in corresponding to a second mixed signal TSM(t) which can be mathematically represented as:
$$TSM ( t ) = {\sum }_{s = 1}^{v} [ SM ( {t}_{s} ) {b}_{s} ( t ) ]$$
selecting a predetermined synchronous signal sin(w₀t), generating a third mixed signal TSMS(t) which can be mathematically represented as: TSMS(t)=sin(pw₀t)TSM+sin(qw₀t);
wherein, w₀ is basic angular frequency, and w₀, p, qεR, tε[T₀,T₁].

8. The method as in claim 7, wherein
$$P = \frac{r + 1}{2} ,$$
r is a positive integer including zero, q can be either ½ or 1, and
$${w}_{0} = \frac{2 π}{{T}_{1}} .$$

9. The method of claim 7 further comprising steps for extracting a proposed synchronous signal from said third mixed signal TSMS(t):
solving said predetermined linearly independent group ᵢaⱼ(t) and said predetermined synchronous signal sin(w₀t) with homogeneous ordinary difference equation method and obtaining 2n−3 values of constant coefficients aᵤ(1), aᵤ(2), . . . aᵤ(2n−3);
Sampling said received third mixed signal TSMS(t), getting one sample every predetermined time delay within a time period and obtaining total of 2n−1 samples, said 2n−1 samples being able to be mathematically represented as yₖ₋₂ₙ₊₂, yₖ₋₂ₙ₊₃, . . . yₖ; and
Processing said 2n−1 samples and producing said proposed synchronous signal, said processing method being able to be mathematically represented as:
[yₖ₋₂ₙ₊₂+aᵤ(2n−3)yₖ₋₂ₙ₊₃+aᵤ(2n−4)yₖ₋₂ₙ₊₄+ . . . +aᵤ(1)yₖ₋₁+yₖ]* Mᵤ,
wherein
$${M}_{u} = \frac{1}{2 \cdot {\prod }_{i = 1}^{u - 1} ( cos {θ}_{u} - cos {θ}_{i} )} \cdot \frac{1}{{\prod }_{i = u + 1}^{n} ( cos {θ}_{u} - cos {θ}_{i} )} .$$

10. The method as in claim 7 further comprising steps for extracting a proposed synchronous signal from said third mixed signal TSNMS(t):
solving said predetermined linearly independent group ᵢaⱼ(t) and said predetermined synchronous signal sin(w₀t) with homogeneous ordinary differential equation method and obtaining n−2 values of constant coefficients αᵤ(1), αᵤ(2), . . . αᵤ(n−2);
In a time period, received said third mixed signal TSMS(t) is mathematically represented as y(t), and using 2^{nd} order differentiators to obtain n−1 derivatives of y(t), said n−1 derivatives being able to be represented as D²ⁿ⁻²y(t), D²ⁿ⁻⁴y(t), . . . D²y(t), wherein D^{x}y(t) is the x^{th} derivative of y(t); and
Processing said n−1 derivatives and obtaining said proposed synchronous signal, said processing method being able to be mathematically represented as:
[D²ⁿ⁻¹+αᵤ(n−2)D²ⁿ⁻⁴+αᵤ(n−3)D²ⁿ⁻⁶+ . . . +αᵤ(1)D²+1]*Nᵤ
wherein αᵤ(j) is the coefficient of D^{2n-2j} j=1,2, . . . , n−2, after development of
$${\prod }_{i = 1}^{u - 1} ( {D}^{2} + {w}_{i}^{2} ) {\prod }_{i + u + 1}^{n} ( {D}^{2} + {w}_{i} ) , and , {N}_{u} = \frac{1}{{\prod }_{i = 1}^{u - 1} ( - {w}_{u}^{2} + {w}_{i}^{2} )} * \frac{1}{{\prod }_{i + 1}^{n} ( - {w}_{u}^{2} + {w}_{i}^{2} )} .$$

11. The method of claim 7 further comprising steps for separating said third mixed signal TSMS(t):
extracting said synchronous signal sin(qw₀t) by the method of claim 9, said synchronous signal sin(qw₀t) being used as the time controlled signal for subsequent analysis;
Separating signals SM(t₁)b₁(t), SM(t₂)b₂(t), . . . SM(tᵥ)bᵥ(t) which contain synchronous signals bᵥ(t) by the method of claim 9;
obtaining SM(t₁), SM(t₂), . . . , SM(tᵥ) signals according to dividing bₛ(tᵣ) from SM(t₁)bₛ(tᵣ), SM(t₂)bₛ(tᵣ), . . . SM(tᵥ)bₛ(tᵣ) in respectively;
Transforming said SM(t₁), SM(t2), . . . , SM(tᵥ) signals into serial signals;
Using m band pass filters to filter said serial signals, wherein the band width of each of said m band pass filters is from
$${A}_{v} \frac{{T}_{1}}{v} Hz ∼ ( {A}_{v} \frac{{T}_{1}}{v} + \frac{{T}_{1}}{2 v} ) Hz , v = 1 , 2 , … m ;$$
Using the methods of claim 9 to separate each of the S₁(tⱼ)ᵢaⱼ(t), S₂(tⱼ)₂aⱼ(t), . . . , Sₘ(tⱼ)ₘaⱼ(t), j=1,2, . . . , n; and
Dividing each of S₁(tⱼ)ᵢaⱼ(t), S₂(tⱼ)₂aⱼ(t), . . . , Sₘ(tⱼ)ₘaⱼ(t) by the corresponding ᵢaⱼ(t) to obtain Sᵢ(t).

12. The method of claim 7 further comprising steps for separating said processed mixed signal TSMS(t):
extracting said synchronous signal sin(qw₀t) by the method of claim 10, said synchronous signal sin(qw₀t) being used as the time controlled signal for subsequent analysis;
Separating signals SM(t₁)b₁(t), SM(t₂)b₂(t), . . . SM(tᵥ)bᵥ(t) which contain synchronous signals bᵥ(t) by the method of claim 10;
obtaining SM(t₁), SM(t₂), . . . , SM(tᵥ) signals according to dividing bₛ(tᵣ) from SM(t₁)bₛ(tᵣ), SM(t₂)bₛ(tᵣ), . . . SM(tᵥ)bₛ(tᵣ), in respectively;
Transforming said signals SM(t₁), SM(t₂), . . . , SM(tᵥ) into serial signals;
Using m band pass filters to filter said serial signals, wherein, the band width of each of said m band pass filters is from
$${A}_{v} \frac{{T}_{1}}{v} Hz ∼ ( {A}_{v} \frac{{T}_{1}}{v} + \frac{{T}_{1}}{2 v} ) Hz ,$$
v=1,2, . . . m;
Using the methods of claim 10 to separate each of the S₁(tⱼ)ᵢaⱼ(t), S₂(tⱼ)₂aⱼ(t), . . . , Sₘ(tⱼ)ₘaⱼ(t), j=1,2 . . . n; and
Dividing each of the S₁(tⱼ)ᵢaⱼ(t), S₂(tⱼ)₂aⱼ(t), . . . , Sₘ(tⱼ)ₘaⱼ(t) by the corresponding ᵢaⱼ(t) to obtain Sᵢ(t) .

13. An apparatus for processing a plurality of signals Sᵢ(t), said apparatus comprising:
at least a receiving unit, for receiving said plurality of signals Sᵢ(t)
a plurality of A/D converters, for sampling and digitizing said plurality of signals Sᵢ(t)
a plurality of signal generators, for generating linearly independent signals ᵢaⱼ(t);
a plurality of first multipliers, for calculating the product functions of Sᵢ(tⱼ) multiplying by ᵢaⱼ(t), wherein Sᵢ(tⱼ) is the j^{th} sample of said plurality of signals Sᵢ(t);
at least a first adder, for calculating a first mixed signal SM(t), wherein
$$SM ( t ) = {\sum }_{i = 1}^{m} {S}_{i}^{o} ( t ) ;$$
a synchronous signal generator, for generating a synchronous signal sin(w₀t), within said time period [T₀,T₁]; and
at least a second multiplier and second adder, for calculating a second mixed signal SMS(t), wherein SMS(t)=Sin(pw₀t)×SM(t)+Sin(qw₀t).

14. The apparatus as in claim 13, further comprising a transmitter for transmitting said second mixed signal SMS(t).

15. The apparatus as in claim 14, further comprising a receiver for receiving said second mixed signal SMS(t), said receiver comprising:
at least a sampling unit, for sampling 2n−1 samples from said second mixed signal SMS(t), said samples being able to be mathematically represented as:
yₖ₋₂ₙ₊₂, yₖ₋₂ₙ₊₃, . . . yₖ;
a signal generator, for producing 2n−3 predetermined constant coefficients aᵤ(1), aᵤ(2), . . . aᵤ(2n−3); and
a plurality of multipliers and adders, for producing an output signal:
[yₖ₋₂ₙ₊₂+aᵤ(2n−3)yₖ₋₂ₙ₊₃+aᵤ(2n−4)yₖ₋₂ₙ₊₄+ . . . +aᵤ(1)yₖ₋₁+yₖ]* Mᵤ,
wherein
$${M}_{u} = \frac{1}{2 \cdot {\prod }_{i = 1}^{u - 1} ( cos {θ}_{u} - cos {θ}_{i} )} \cdot \frac{1}{{\prod }_{i = u + 1}^{n} ( cos {θ}_{u} - cos {θ}_{i} )} .$$

16. The apparatus as in claim 14, further comprising a receiver for receiving said second mixed signal SMS(t), said receiver comprising:
a plurality of differentiators, for calculating derivatives of said second mixed signal SMS(t) and obtaining n−1 derivatives D²ⁿ⁻² y(t), D²ⁿ⁻⁴ y(t), . . . D² y(t), wherein D^{x} y(t) is the x^{th} derivative of y(t);
A signal generator, for producing n−2 predetermined constant coefficients αᵤ(1), αᵤ(2), . . . αᵤ(n−2) ; and
A plurality of multipliers and adders, for producing an output signal: [D²ⁿ⁻¹+αᵤ(n−3)D²ⁿ⁻⁴+αᵤ(n−3)D²ⁿ⁻⁶+ . . . +αᵤ(1)D²+1]* Nᵤ, wherein αᵤ(j) are coefficients of D^{2n-2j} j=1,2, . . . , n−2 after development of
$${\prod }_{i = 1}^{u - 1} ( {D}^{2} + {w}_{i}^{2} ) {\prod }_{i + u + 1}^{n} ( {D}^{2} + {w}_{i} ) ; and$$
$${N}_{u} = \frac{1}{{\prod }_{i = 1}^{u - 1} ( - {w}_{u}^{2} + {w}_{i}^{2} )} * \frac{1}{{\prod }_{i + 1}^{n} ( - {w}_{u}^{2} + {w}_{i}^{2} )} .$$

17. An apparatus for using the method according to claim 7, said apparatus comprising:
m A/D converters, for sampling and digitizing said plurality of signals Sᵢ(t);
m×n signal generators, for producing said linearly impendent signal ᵢaⱼ(t);
wherein the frequency range of ᵢaⱼ(t) is
$${A}_{i} \frac{{T}_{1}}{v} H z ∼ ( {A}_{i} \frac{{T}_{1}}{v} + \frac{{T}_{1}}{2 v} ) H z ,$$
v=1,2, . . . m, said synchronous signals being mathematically represented as sin(w₀t);
m×n first multipliers, for calculating the product function of Sᵢ(tⱼ) multiplying by ᵢaⱼ(t), wherein Sᵢ(tⱼ) is the j^{th} sample of Sᵢ(t);
at least a first adder, for calculating a mixed signal SM(t), wherein
$$SM ( t ) = {\sum }_{i = 1}^{m} {S}_{i}^{o} ( t ) ;$$
a synchronous signal generator, for producing synchronous signals within a time period [T₀,T₁];
at least a converter, for sampling v samples from SM(t);
a plurality of third signal generators producing v lineally independent function groups bₛ(t);
at least a second multiplier and second adder, for calculating said second mixed signal TSM(t) of said mixed signal SM(tₛ); and
at least a third multiplier and third adder, for calculating said third mixed signal TSMS(t).

18. The apparatus as in claim 17, further comprising a transmitter for transmitting said third mixed signal TSMS(t)

19. The apparatus as in claim 17, further comprising a receiver for receiving said third mixed signal TSMS(t), said receiver comprising:
at least a sampling unit for sampling 2n−1 samples from said third mixed signal TSMS(t), wherein said samples are mathematically represented as
yₖ₋₂ₙ₊₂, yₖ₋₂ₙ₊₃, . . . yₖ;
a signal generator producing 2n−3 constant coefficients aᵤ(1), aᵤ(2), aᵤ(2n−3) ; and
a plurality of multipliers and adders, for producing an output signal, said output signal being able to be mathematically represented as
[yₖ₋₂ₙ₊₂+aᵤ(2n−3)yₖ₋₂ₙ₊₃+aᵤ(2n−4)yₖ₋₂ₙ₊₄+ . . . +aᵤ(1)yₖ₋₁+yₖ]* Mᵤ,
wherein
$${M}_{u} = \frac{1}{2 \cdot {\prod }_{i = 1}^{u - 1} ( cos {θ}_{u} - cos {θ}_{i} )} \cdot \frac{1}{{\prod }_{i = u + 1}^{n} ( cos {θ}_{u} - cos {θ}_{i} )} .$$

20. The apparatus as in claim 17, further comprising a receiver for receiving said third mixed signal TSMS(t), said receiver comprising:
a plurality of differentiators, for calculating derivatives of said third mixed signal TSMS(t) and obtaining n−1 derivatives D²ⁿ⁻²y(t), D²ⁿ⁻⁴y(t), . . . D²y(t), wherein D^{x}y(t) is the x^{th} derivative of y(t);
A signal generator, for producing n−2 predetermined constant coefficients αᵤ(1), αᵤ(2), . . . αᵤ(n−2); and
A plurality of multipliers and adders producing an output signal
[D²ⁿ⁻¹+αᵤ(n−1)D²ⁿ⁻⁴+αᵤ(n−3)D²ⁿ⁻⁶+ . . . +αᵤ(1)D²+1]*Nᵤ,
wherein αᵤ(j) are coefficients of D^{2n-2j} after development of
$${\prod }_{i = 1}^{u - 1} ( {D}^{2} + {w}_{i}^{2} ) {\prod }_{i + u + 1}^{n} ( {D}^{2} + {w}_{i} ) , j = 1 , 2 , … , n - 2 , and$$
$${N}_{u} = \frac{1}{{\prod }_{i = 1}^{u - 1} ( - {w}_{u}^{2} + {w}_{i}^{2} )} * \frac{1}{{\prod }_{i + 1}^{n} ( - {w}_{u}^{2} + {w}_{i}^{2} )} .$$
